(19) United States
(12) Patent Application Publication
(10) Pub. No.: US 2012/0317357 A1
(43) Pub. Date: Dec. 13, 2012

(54) System And Method For Identifying Location Of A Disk Drive In A SAS Storage System

(75) Inventor: Haim Kopylovitz, Herzliya (IL)

(73) Assignee: INFINIDAT LTD., Herzliya (IL)

(21) Appl. No.: 13/158,917

(22) Filed: Jun. 13, 2011

(51) Int. Cl. G06F 12/00

(52) U.S. Cl. 711/114; 711/E12.001

(57) ABSTRACT

SAS technology does not offer an explicit solution to the identification of the physical location of an end device. Accordingly, there is provided a method and system for enabling to identify the physical location of a disk in a storage system configured with SAS technology. According to the presently disclosed subject matter a control device in a storage system is operable to determine the physical location of the disks within each enclosure. The control device can be made operable also to determine the location of the enclosures within the rack and thereby obtain the full mapping of the disks within the storage system. This mapping enables, inter alia, to associate between a SCSI target number of a disk and its physical location within the storage system.

### FIELD OF THE PRESENTLY DISCLOSED SUBJECT MATTER

This invention relates to the field of SAS storage systems and more specifically to the field of organization and management of such systems.

### BACKGROUND

Serial Attached SCSI (SAS) is a technology for data transfer between computer network storage devices, such as hard drives and tape drives, which is based on a point-to-point serial protocol and replaces parallel SCSI bus technology. A SAS domain is an input/output (I/O) system that includes a network of devices that communicate with one another in accordance with SAS protocol. In an SAS domain one or more initiators can be each connected with a plurality of targets. An initiator is a device that can initiate SCSI commands and receive responses, and a target is an end device such as a disk drive, which can receive and handle SCSI commands. One major advantage of SAS technology over previous technologies, such as parallel SCSI, is that it enables a single SAS domain to contain over 16,000 SCSI targets. Thus, a single initiator can be connected to a cloud of targets. This can be accomplished, inter alia, with the help of (SAS) expanders, which act as switches between SAS initiators and SAS targets and are capable of connecting a host to multiple SAS end devices.

Considering the complexity and scalability of SAS domains, the management of such domains is a significant challenge. Thus, there is a need in the art for a new method and system which enable to improve the management of communication networks implementing SAS technology.

Prior art references considered to be relevant as background to the presently disclosed subject matter are listed below. Acknowledgement of the references herein is not to be inferred as meaning that these are in any way relevant to the patentability of the presently disclosed subject matter.

US 20090083484 discloses a system and method for performing zoning of devices, such as Serial Attached SCSI (SAS) devices, for example, in a storage area network (SAN) in which all host systems of the SAN are automatically mapped to all of the storage systems is provided. Mechanisms for automatically mapping backend storage enclosures to appropriate storage system controllers on the SAN are provided. The zoning is automatically performed based on whether ports/phys are coupled to host systems, storage systems, and whether there are storage system controllers associated with the storage systems. Based on the automatic zoning, mapping of the storage devices of the storage systems to the host systems may be automatically performed via zone permission tables. By automating the zoning, users that do not necessarily have a detailed knowledge of the storage device communication protocol or SANs may configure the SAN even if it utilizes a complex and large architecture.

### SUMMARY

According to one aspect of the presently disclosed subject matter there is provided a method of identifying physical location of disk drives in a SAS storage system comprising one or more host bus adapters (HBAs), each HBA comprising one or more ports, connecting between the HBA and at least one disk enclosure, each enclosure comprising a plurality of disk drives, each disk drive located in a respective bay, the method comprising:

obtaining SAS address of one or more disk drives among the plurality of disk drives; obtaining SAS address of each bay in the respective disk enclosures; associating, based on the SAS address of the disk drives and bays, between the one or more disk drives among the plurality of disk drives and the respective bays; obtaining mapping information indicative of the location of the bays in the respective disk enclosure; and determining, based on the physical location of its respective bay, the physical location, within respective disk enclosures, of the one or more disk drives among the plurality of disk drives.

According to certain embodiment of the presently disclosed subject matter, the storage system comprises at least one control device comprising a plurality of ports and is connected to a rack comprising a plurality of enclosures, each enclosure operatively connected to a corresponding port, the method further comprising:

obtaining data indicative of ports connected to each of the enclosures connected to the at least one control device and of the SAS addresses identifying each of the enclosures, thereby obtaining a first data associating between each port among the plurality of ports and SAS addresses of the respective enclosures; obtaining a second data associating between each port among the plurality of ports and between a location of respective enclosures within the rack; and associating between the port in the first data and the port in the second data, thereby determining the location of each enclosure identified by the respective SAS address.

According to another aspect of the presently disclosed subject matter there is provided a method of identifying the physical location of a disk drive of interest in a SAS storage system comprising one or more host bus adapters (HBAs), each HBA comprising one or more ports, connecting between the HBA and at least one disk enclosure, each enclosure comprising a plurality of disk drives, each disk drive located in a respective bay, the method comprising:

obtaining SAS address of the disk drive of interest and a respective enclosure of interest; obtaining SAS address of each bay in the respective disk enclosures; associating between the disk drive of interest and its respective bay, by searching for a bay with a SAS address which is identical to the SAS address of the disk drive of interest; and obtaining mapping information indicative of the location of the bays in the respective disk enclosure; identifying in the mapping information data indicative of the locating of the respective bay; and determining, based on the physical location of the respective bay, the physical location, within respective disk enclosures, of the disk drive of interest.

According to certain embodiments of the presently disclosed subject matter the disk drive of interest is identified by its SCSI target number, the method further comprising: obtaining SAS address of the disk drive of interest and its enclosure, by running an appropriate SCSI command with the SCSI target number of the disk drive of interest.

Accordingly to certain embodiments of the presently disclosed subject matter the storage system comprises at least one control device comprising a plurality of ports and is connected to a rack comprising a plurality of enclosures, each enclosure operatively connected to a corresponding port, the method further comprising: obtaining data indicative of ports connected to each of the enclosures connected to the at least one control device and of the SAS addresses identifying each of the enclosures; identifying the SAS address of the enclosure of interest within the data and identifying the respective port of the enclosure of interest, thereby obtaining a first data; obtaining data indicative of the location of an enclosure connected to the respective HBA, thereby obtaining a second data; associating between the port in the first data and the port in the second data, thereby determining the location of the enclosure of interest in the rack.

According to a further aspect of the presently disclosed subject matter there is provided a management unit, operatively connectible to an SAS storage system comprising one or more host bus adapters (HBAs) each HBA comprising one or more ports, connecting between the HBA and at least one disk enclosure, each enclosure comprising a plurality of disk drives, each disk drive located in a respective bay, the management module being operable to receive identifiers of one or more disk drives among the plurality of disk drives;

determine, with the help of a SCSI command corresponding to the identifiers, respective SAS addresses of the one or more disk drives among the plurality of the disk drives and SAS addresses of disk enclosures comprising, respectively, the one or more disk drives among the plurality of the disk drives; obtain a SAS address of each bay in the respective disk enclosures; associate, based on the SAS address of the disk drives and bays, between the one or more disk drives among the plurality of disk drives and the respective bays; obtain mapping information indicative of the location of the bays in the respective disk enclosure; and determine, based on the physical address of its respective bay, the physical location, within respective disk enclosures, of the one or more disk drives among the plurality of disk drives.

According to certain embodiments of the presently disclosed management unit, the SAS storage system comprises at least one control device comprising a plurality of ports and is connected to a rack comprising a plurality of enclosures, each enclosure operatively connected to a corresponding port, wherein the management unit is further operable to receive data indicative of, ports connected to each of the enclosures connected to the at least one control device, and of the SAS addresses identifying each of the enclosures, thereby obtain a first data associating between each port among the plurality of ports and a SAS address of the respective enclosure; receive a second data associating between each port among the plurality of ports and between a location of respective enclosures within the rack; and associate between the port in the first data and the port in the second data, thereby determining the location of each enclosure identified by a respective SAS address.

According to yet a further aspect of the presently disclosed subject matter there is provided a program storage device readable by machine, tangibly embodying a program of instructions executable by the machine to perform method steps of identifying physical location of disk drives in an SAS storage system comprising one or more host bus adapters (HBAs) each HBA comprising one or more ports, connecting between the HBA and at least one disk enclosure, each enclosure comprising a plurality of disk drives, each disk drive located in a respective bay, the method comprising: obtaining SCSI target numbers of one or more disk drives among the plurality of disk drives; determining, with the help of a SCSI command corresponding to the SCSI target numbers, respective SAS addresses of the one or more disk drives among the plurality of the disk drives and SAS addresses of disk enclosures comprising, respectively, the one or more disk drives among the plurality of the disk drives; obtaining SAS address of each bay in the respective disk enclosures; associating, based on the SAS address of the disk drives and bays, between the one or more disk drives among the plurality of disk drives and the respective bays; obtaining mapping information indicative of the location of the bays in the respective disk enclosure; and determining, based on the physical address of its respective bay, the physical location, within respective disk enclosures, of the one or more disk drives among the plurality of disk drives.

According to certain embodiments of the presently disclosed program storage device, wherein the SAS storage system comprises at least one control device comprising a plurality of ports and is connected to a rack comprising a plurality of enclosures, each enclosure operatively connected to a corresponding port, the program of instructions executable by the machine to perform method steps further comprises:

obtaining data indicative of, ports connected to each of the enclosures connected to the at least one control device, and of the SAS addresses identifying each of the enclosures, thereby obtaining a first data associating between each port among the plurality of ports and a SAS address of the respective enclosure;

obtaining a second data associating between each port among the plurality of ports and between a location of respective enclosures within the rack; and

associating between the port in the first data and the port in the second data, thereby determining the location of each enclosure identified by a respective SAS address.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of a functional block diagram of a computer storage system, according to the presently disclosed subject matter;

FIG. 2 is a schematic illustration showing a disk rack as known in the art;

FIG. 2b is an illustration showing an example of mapping information of an enclosure;

FIG. 3 is a schematic illustration of an example of architecture of a storage system, in accordance with the presently disclosed subject matter;

FIG. 4 is a schematic illustration of a second example of architecture of a storage system, in accordance with the presently disclosed subject matter;

FIG. 5a is a flowchart illustrating the operations which are performed for determining the location of disk drives, in accordance with the presently disclosed subject matter;

FIG. 5b is a flowchart illustrating the operations which are performed for determining the location of enclosures in a rack, in accordance with the presently disclosed subject matter;

FIG. 6a is a flowchart illustrating the operations which are performed for determining the location of a disk drive of interest, in accordance with the presently disclosed subject matter; and

FIG. 6b is a flowchart illustrating the operations which are performed for determining the location of an enclosure of interest in a rack, in accordance with the presently disclosed subject matter.

### DETAILED DESCRIPTION

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “receiving”, “associating”, “determining”, “identifying”, “providing”, “searching” or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

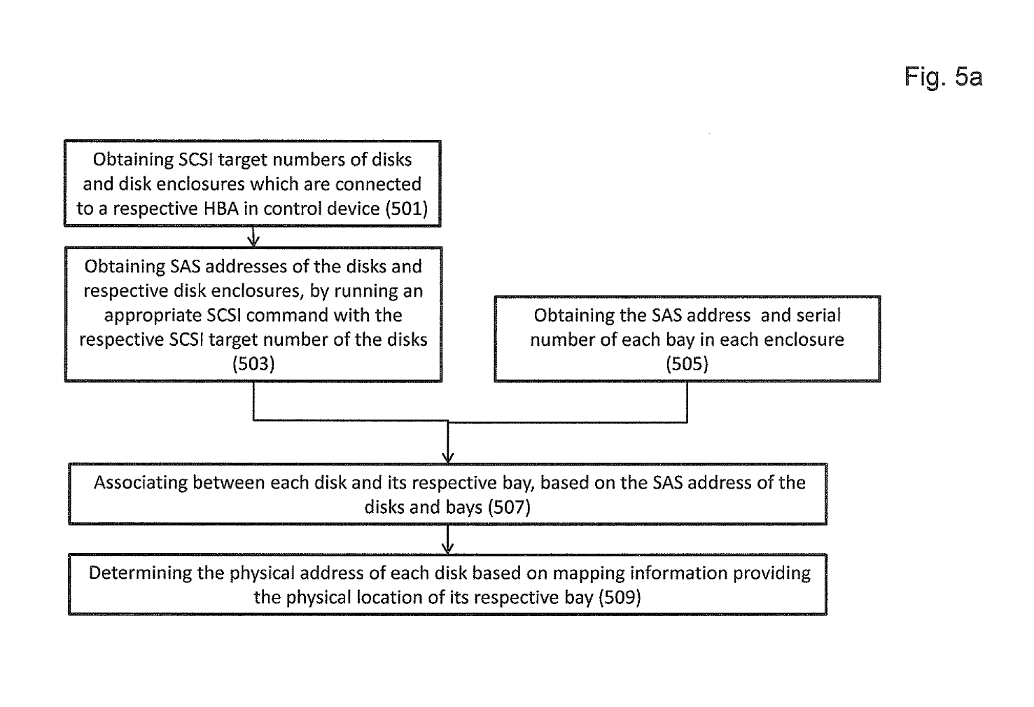

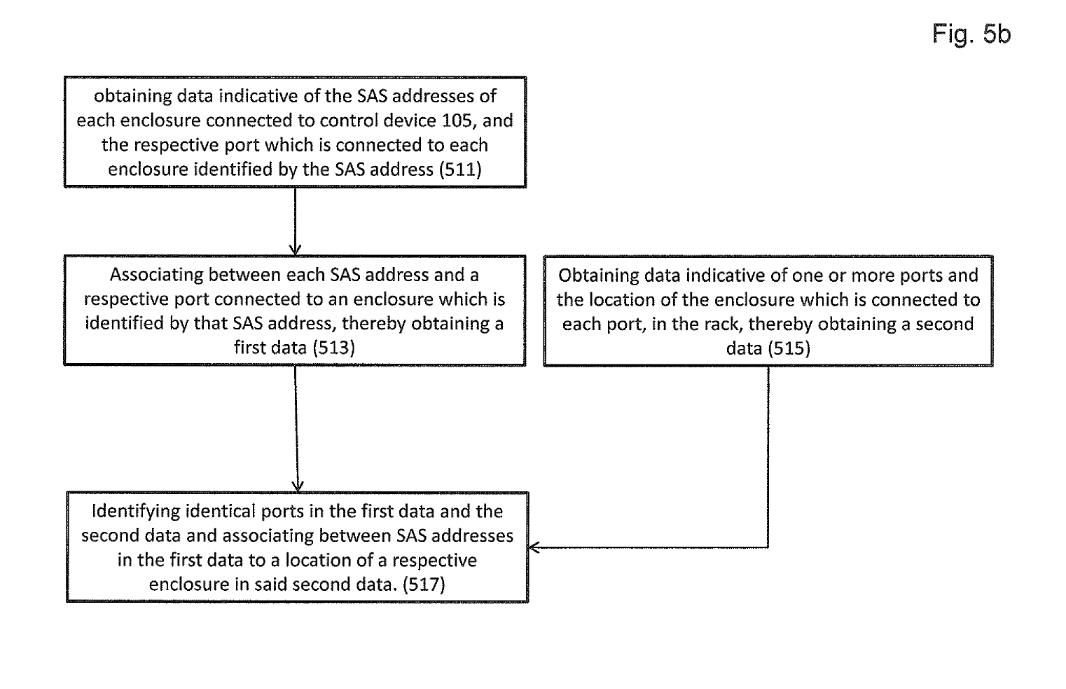

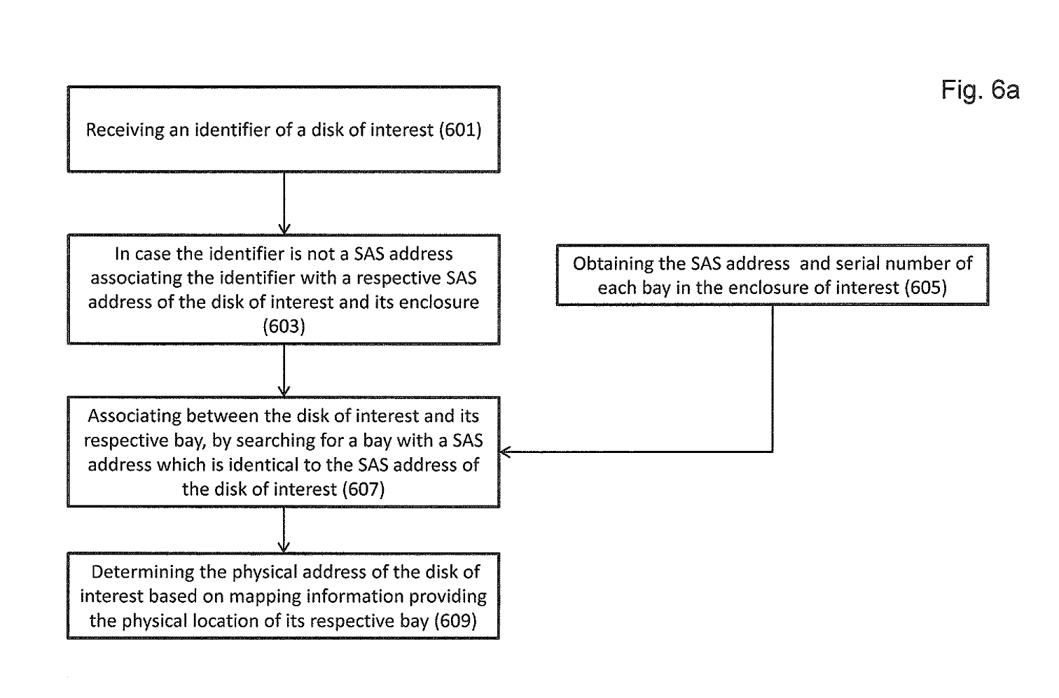

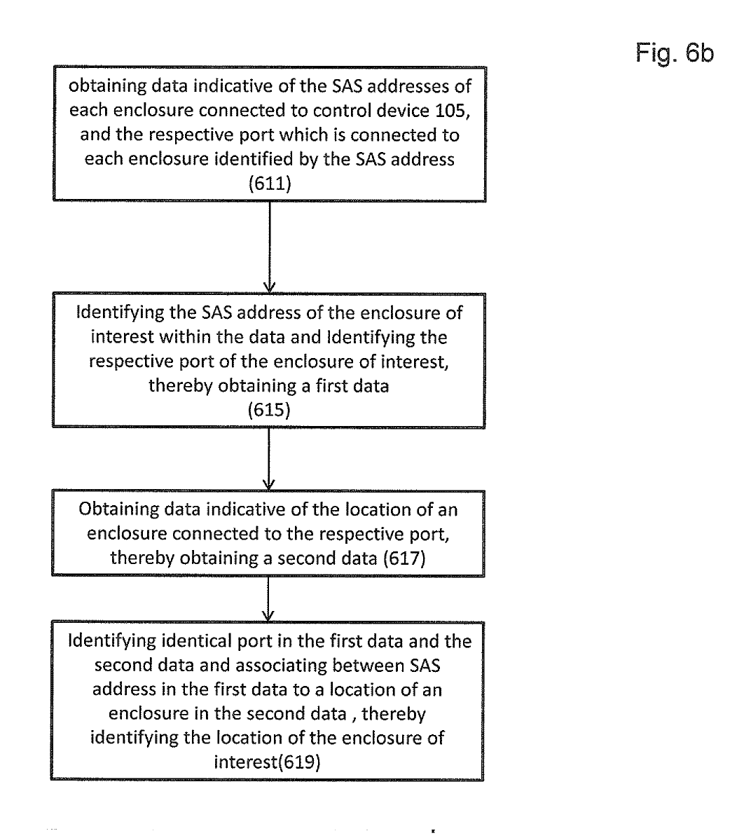

In embodiments of the presently disclosed subject matter, fewer, more and/or different stages than those shown in FIGS. 5a, 5b, 6a and 6b may be executed. In embodiments of the presently disclosed subject matter one or more stages illustrated in FIGS. 5a, 5b, 6a and 6b may be executed in a different order and/or one or more groups of stages may be executed simultaneously.

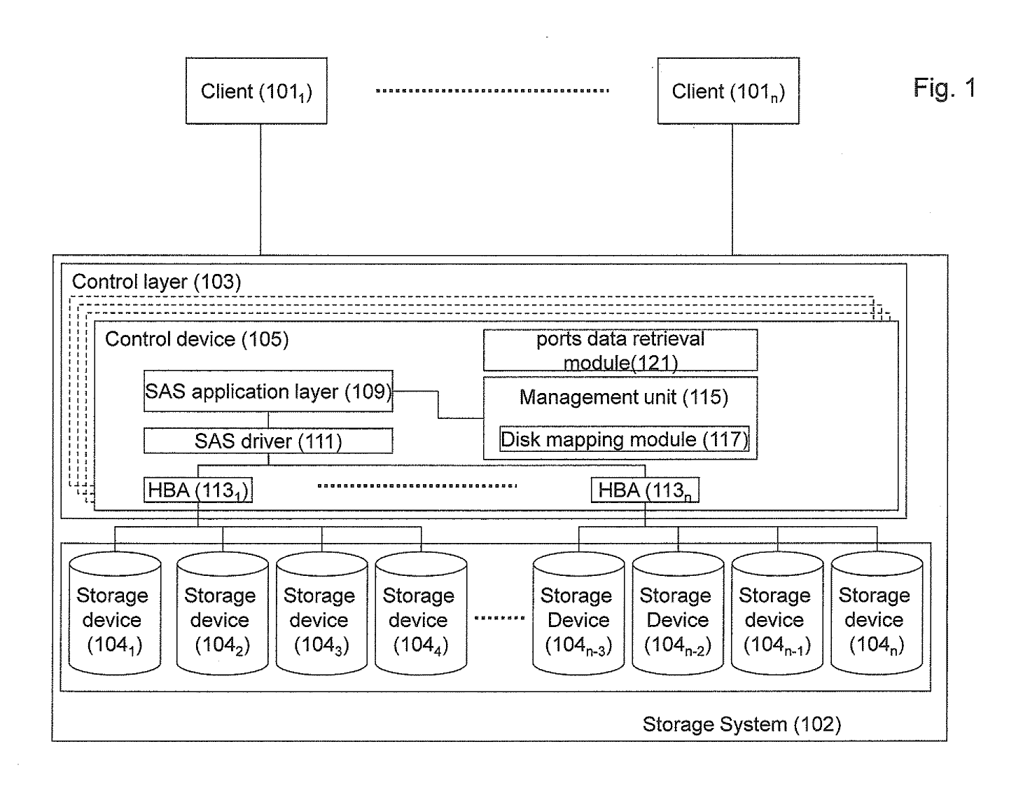

FIG. 1 illustrates a general schematic of the system architecture in accordance with an embodiment of the presently disclosed subject matter. Certain embodiments of the present invention are applicable to the architecture of a computer system described with reference to FIG. 1. However, the invention is not bound by the specific architecture; equivalent and/or modified functionality may be consolidated or divided in another manner and may be implemented in any appropriate combination of software, firmware and hardware. Those versed in the art will readily appreciate that the invention is, likewise, applicable to any computer system and any storage architecture implementing a virtualized storage system. In different embodiments of the invention the functional blocks and/or parts thereof may be placed in a single or in multiple geographical locations (including duplication for high-availability); operative connections between the blocks and/or within the blocks may be implemented directly (e.g. via a bus) or indirectly, including remote connection. The remote connection may be provided via Wire-line, Wireless, cable, Internet, Intranet, power, satellite or other networks and/or using any appropriate communication standard, system and/or protocol and variants or evolution thereof (as, by way of unlimited example, Ethernet, iSCSI, Fiber Channel, etc.). By way of non-limiting example, the invention may be implemented in a SAS grid storage system disclosed in U.S. patent application Ser. No. 12/544,743 filed on Aug. 20, 2009, assigned to the assignee of the present application and incorporated herein by reference in its entirety.

Bearing this in mind, attention is drawn to FIG. 1, illustrating a schematic functional block diagram of a computer storage system, according to the presently disclosed subject matter. The storage system comprises a storage control layer 103 comprising one or more storage control devices 105 operatively connected with a plurality of data storage devices 104₁₋ₙ constituting a physical storage space optionally distributed over one or more storage nodes, wherein the storage control layer 103 is operable to control interface operations (such as I/O operations) between one or more clients and data storage devices 104₁₋ₙ. In FIG. 1 a single control device 105 is illustrated in detail. This is done for the purpose of clarity and simplicity only and should not be construed as limiting in any way. As mentioned above and indicated by the rectangles with the broken lines, control layer 103 can include a plurality of control devices.

According to the presently disclosed subject matter, storage system 102 is configured in accordance with SAS (serially attached SCSI) technology. To this end storage system 102 comprises appropriate hardware and is operable to operate in accordance with the SAS protocol. Each control device 105 comprises at least one host bus adaptor (HBA), where each HBA operates as a SAS initiator. Depending on the scalability of storage system 102 and the number of storage devices 104₁₋ₙ, control device 105 can comprise different numbers of HBAs, illustrated in FIG. 1 as HBAs 113₁₋ₙ.

In general, a single HBA can connect via a plurality of ports to a plurality of end devices (i.e. targets) including for example, storage devices 104₁₋ₙ. In the example illustrated in FIG. 1 each HBA is connected to 4 enclosures by means of 4 ports. In some cases the targets which are directly connected to an HBA (via a port), can be further connected to one or more SAS expanders for facilitating the connection of a greater number of end devices in the SAS domain.

According to the presently disclosed subject matter, storage devices 104₁₋ₙ schematically illustrate storage devices of any size or form. For example, any one of storage devices 104₁₋ₙ can represent a single disk drive (disk), a disk enclosure comprising a plurality of disks (e.g. where each disk is indirectly connected to an HBA e.g. via a cascade of one or more expanders), or a rack comprising a plurality of enclosures.

According to one example, a storage system can be implemented on a single computer which is operatively connected to plurality of storage devices 104₁₋ₙ (e.g. computer disk drives). In such case control layer 103 can be embedded within the computer. According to another example, storage system 102 can be implemented as at least one dedicated server computer, associated with a plurality of client computers (workstations, application servers, etc.) illustrated as 101₁₋ₙ sharing common storage means provided by a virtualized storage system 102. The storage control layer 103 can be operable to handle a virtual representation of physical storage space and to facilitate necessary mapping between the physical storage space and its virtual representation. Control layer 103 can also comprise or is otherwise associated with one or more processers configured, inter alia, to manage and control relevant components and operations, and to perform tasks in response to instructions.

Control layer 103 can be further operable to run a management process (e.g. with the help of a management unit 115), by the operating system of a control device 105 operable for executing management related tasks. Such tasks can include for example, volume creation and deletion, snapshot creation, definition of access permissions, querying data from the core process, etc. According to the presently disclosed subject matter, management unit 115 is configured to communicate with a SAS application layer 109, which is connected to SAS driver 111 being further connected to HBA 113₁₋ₙ, for facilitating the SAS protocol, in order to communicate with storage devices 104₁₋ₙ and perform tasks related to the storage devices.

In some cases management of the storage system may require to identify the actual physical location of a given disk drive (disk) within storage devices 104₁₋ₙ. For example, the physical location of a disk is sometimes required for maintenance purposes, when a technician has to replace a failed disk, and he needs to know its physical location within the storage system. Management module 115 can be operable to receive a disk failure message (via SAS application layer 109) indicating that one of the disks, which is connected to the control device, malfunctions and should be replaced. In a SCSI operated system, a disk (e.g. in a disk failure notification) is identified by its SCSI target number. However, this number does not indicate the physical location of the disk within its enclosure or the location of the enclosure within the rack. Unfortunately it has been known to occur that an operating disk, instead of a damaged one, has been erroneously replaced by a technician. The greater the number of disks in the storage system, the more severe the problem of identifying the correct disk. Identifying the correct disk is also a concern in the context of reliability. Thus, for instance, when a RAID group is defined, it may be required to associate to the same RAID group only a pair of disks from different enclosures and accordingly the location of the disk drives needs to be determined.

SAS technology does not offer an straightforward solution to the identification of the physical location of an end device. Accordingly, there is provided a method and system for enabling to identify the physical location of a disk in a storage system configured with SAS technology. According to the presently disclosed subject matter management unit 115 comprises a disk mapping module 117 which is operable to determine the physical location of the disks within each enclosure. Disk mapping module 117 can be made operable also to determine the location of the enclosures within the rack and thereby obtain the full mapping of the disks within the storage system. This mapping enables, inter alia, to associate between a SCSI target number of a disk and its physical location within the storage system.

For the sake of example, assume that each storage devices 104₁₋ₙ illustrated in FIG. 1 represents a disk enclosure wherein the enclosures are located in one or more racks. Disk mapping module 117 can be operable to provide the physical location of the disk within each of these enclosures.

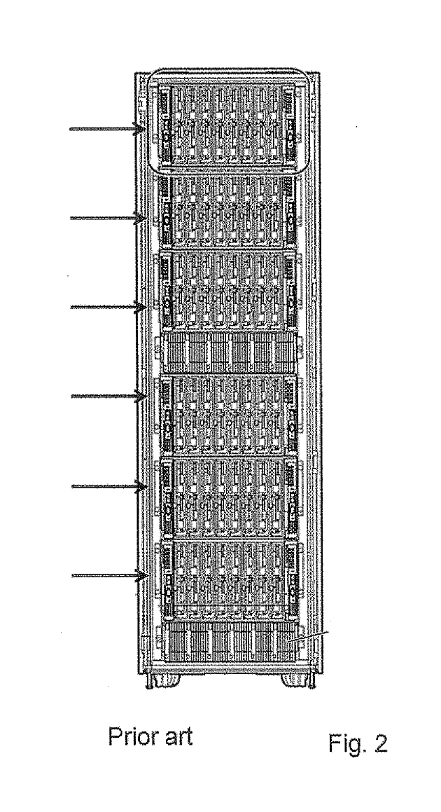

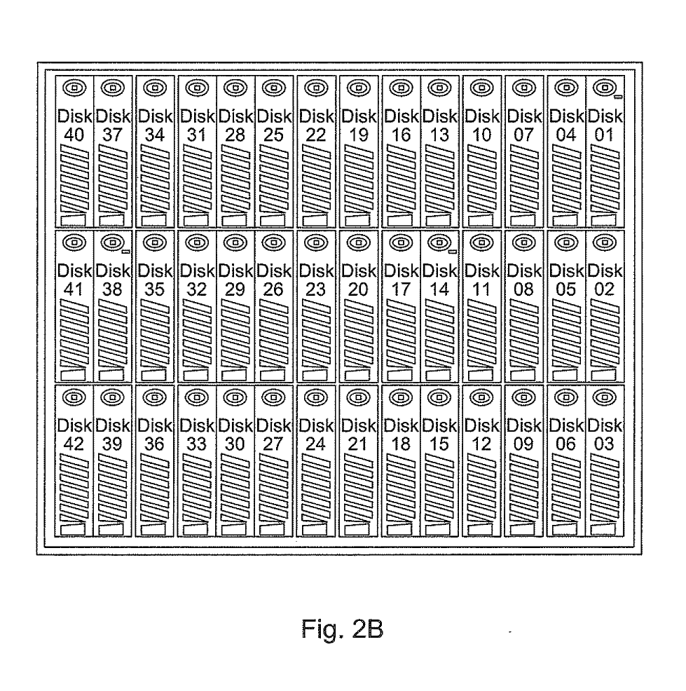

FIG. 2 is a schematic illustration showing a typical disk rack comprising 6 enclosures indicated by arrows. Each enclosure comprises a plurality of disks.

In general, on boot time, each initiator (e.g. HBA 113₁₋ₙ) undergoes a discovery process during which it learns which devices are accessible to it within the system. The discovery process is executed by the SAS application layer 109 and enables to obtain a SCSI target number of the devices in the pertinent SAS domain. In the discovery process the available disks and also the available enclosures appear with a target number in terms of HCTL (host, channel, target, LUN). Disks are identified as Type 0 devices and enclosures as Type 13 devices. After the discovery process is completed, it is possible to send an enquiry SCSI command (command 12) to any of the targets (including both the disks and the enclosures) with the target number and receive in response to the SCSI command, the SAS address of the target identified by the specified SCSI target numbers.

A SAS address is an 8-digit hexadecimal number, which is an identifier of the device and it is assigned by the device manufacturer at the factory and stored in hardware or firmware on the device. However, similar to the SCSI target number, the SAS address does not provide any information in respect of the physical location of the device which is associated with a given SAS address.

According to the presently disclosed subject matter, once the discovery process is completed, disk mapping module 117 is operable to communicate with the SAS application layer 109 and request the SAS address of the disks which were identified by their respective SCSI target numbers, during the discovery process.

Each disk enclosure comprises a plurality of bays. A bay is the slot in the enclosure to which a disk is connected. Each bay is identified by a SAS address. In a SAS domain the SAS address of a disk is identical to the SAS address of the bay to which that disk is attached. In addition to a SAS address, each bay is also associated with a serial number which is provided by the manufacturer (e.g. 1 to n). The serial numbers of the bays correspond to the order of appearance of the bays in the enclosure. Mapping information which indicates the location of each bay (identified by its serial number) in the enclosure is available from the manufacturer (or vendor) of the enclosure. FIG. 2b illustrates an example of mapping information of an enclosure. FIG. 2b shows an enclosure with a plurality of slots (or bays), wherein each slot is identified by a serial number.

Disk mapping module 117 is further operable to communicate with enclosures in the storage system using SCSI Enclosure Service (SES). SES is a set of enclosure SCSI commands which enable to access power, cooling, and other non-data characteristics of the enclosures. According to the presently disclosed subject matter, disk mapping module 117, is configured to utilize the SES commands in order to obtain the respective SAS address of bays in one or more enclosures which are connected to storage system 102. In response to a query, the SAS addresses of the bays in an enclosure can be retrieved. The response also includes the serial number of the bay thereby enabling to associate between the SAS address and serial number of a given bay.

Once the SAS addresses of the bays and disks of an enclosure are obtained, disk mapping module 117 is operable to associate between each disk and its corresponding bay, based on their SAS addresses.

Since, as explained above, the physical location of the bay (identified by its serial number) within the enclosure is known, once a bay and its disk are associated, it is possible to identify the physical location of the disk within the enclosure. Accordingly, mapping data indicating the location of the disks which are connected to control device 105 can be generated, associating between the SCSI target number of each disk, its SAS address and its physical location within its enclosure. The mapping data can be stored in a data repository associated with control layer 103. Once this data is available, given a SCSI target number (or SAS address) of a disk, its physical location (within its respective enclosure) can be determined.

In order to provide the full mapping of the disks within a rack holding a plurality of enclosures, it still remains to determine the location of the enclosure in the rack. Although SCSI commands enable to identify the various enclosures by their SAS addresses, they do not explicitly indicate where each enclosure is located in a rack.

As explained above the connection between each HBA and its respective enclosures is facilitated by one or more ports. According to the presently disclosed subject matter, in order to determine the location of the enclosures within the rack, disk mapping module 117 can be further operable to utilize ports-data retrieval module 121 which is configured to provide information specifying the SAS addresses of the enclosures which are connected to control device 105. Furthermore, the information which is provided by ports-data retrieval module 121 is also indicative of a respective port which is connected to each of the specified enclosures.

In one example, for systems which are configured with SAS technology manufactured by LSI (LSI corporate manufactures of LSI SAS 9201-16e HBA) ports-data retrieval module 121 can obtain this information with the help of MPTCTL driver which runs as part of the LSI HBA. The MPTCTL driver is a module which runs as part of a Linux operating system. The MPTCTL driver can be used to identify the SAS addresses of the enclosures, which are connected to control device 105. The SAS addresses are provided by the MPTCTL driver as a vector containing the SAS addresses. The position of each SAS address in the vector is indicative of its respective port (i.e. the port connecting the enclosure to the HBA). Thus, it is possible to associate between a given SAS address of an enclosure listed in the vector and the port to which it is connected, based on the position of the SAS address in the vector.

It should be noted that in other examples or implementations, ports-data retrieval module 121 can be specifically configured to provide the information which is otherwise provided by the MPTCTL driver. Furthermore, this information can be presented in a format other than a vector (e.g. table), and thus, the example of a vector should be construed as non-limiting.

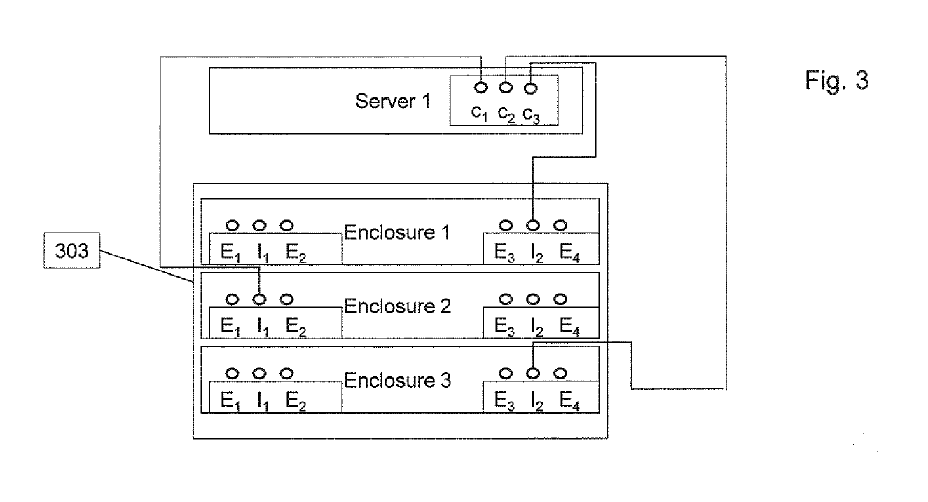

FIG. 3 is a schematic illustration of an example of the architecture of a storage system, in accordance with the presently disclosed subject matter. The system illustrated in FIG. 3 includes a single server (server 1) connected to rack 303 which comprises 3 disk enclosures (Enclosure 1, Enclosure 2 and Enclosure 3). Server 1 represents an example of control device 105 described above with reference to FIG. 1.

Note that in the illustrated example server 1 includes an HBA comprising 3, where each port on control device 105 is identified and labeled with a specific identifier (indicated C1, C2 and C3). The enclosures are connected to server 1 via these ports, wherein each port is connected point to point to a single enclosure. Expanders can be utilized in each enclosure for connecting multiple disks in the enclosure (not shown).

Disk mapping module 117 in server 1 is operable to utilize ports-data retrieval module 121 in order to determine a vector of the connections of the enclosures to server 1, wherein each enclosure in the vector is identified by its SAS address and is located within the vector in a position corresponding to its respective port. As the position of each SAS address in the vector is indicative of its respective port, disk mapping module 117 is operable to associate between the SAS address of the enclosure in the vector and its respective port.

For the sake of example, assuming that the vector which is obtained by ports-data retrieval module 121 is: (SAS address x, SAS address y, SAS address z), and that the first position in the vector is associated with C1, the second position is associated with C2 and third with C3, disk mapping module 117 would associate SAS address x with C1, SAS address y with C2 and SAS address z with C3. The vector representing the connections between enclosures and their respective port, or any other information deduced from this vector, can be stored in a data-repository associated with control device 105 (e.g. server 1). As each port is labeled with its name, the location (on server 1) of a port associated with a given SAS address can be identified.

Furthermore, the positions within the vector can be associated with the respective ports according to a predefined order, which correlates with the location of the ports on control device 105 (e.g. server 1). For example, the positions in the vector can correlate with the physical order of the ports on server 1, from left to right i.e. C1, C2 and C3. Accordingly, the vector which is obtained by ports-data retrieval module 121 can be also indicative of the location of each respective port (on server 1) which is associated with the SAS address in the vector.

Thus, according to the current example, the vector which is obtained by ports-data retrieval module 121 (e.g. with the help of MPTCTL driver) can list the SAS addresses in the following order: SAS address of enclosure 2 in the first position of the vector (since it is connected by port C1 which is first on the left), SAS address of enclosure 3 (since it is connected by port C2 which is second from the left) in the second position of the vector, SAS address of enclosure 1 in the third position of the vector (since it is connected by port C3 which is first on the right). It should be noted that any order can be used and this example should not be construed as limiting.

As the position of a SAS address in the vector is indicative of both the respective port and the physical location of the port on control device 105, it is possible to identify the physical location of an enclosure which is identified by a SAS address in the vector, based on the position of the SAS address in the vector. This can be achieved by locating a respective port and then physically locating the enclosure attached to the HBA via the port which was identified. Once the location of the port on server 1 is identified, the connection from the port to the enclosure can be tracked and the physical location of the enclosure can be thus determined.

According to another example, in order to identify the location of an enclosure within rack 303, the connection of each port to its corresponding enclosure in rack 303, can be recorded and possibly stored in a data-repository associated with control device 105 (e.g. server 1). For example a table (e.g. a hash table) can be used, which associates between each enclosure and its location in the rack, and the port to which it is connected.

Table 1 shows mapping between the ports on server 1 and their corresponding enclosures as illustrated in the example in FIG. 3. The last column in table 1 indicates the position in the vector which is associated with each port.

TABLE 1

| | Position of | | |
|---|---|---|---|
| | Enclosure | | Port's position |
| Enclosure | in rack | Port | in vector |
| Enclosure 1 | 1 (top) | C2 | 2 |
| Enclosure 2 | 2 (middle) | C3 | 3 |
| Enclosure 3 | 3 (bottom) | C1 | 1 |

Control device 105 can run a GUI to enable a user (e.g. technician) to enter the configuration of the connections between ports and enclosures in a rack. The GUI can be displayed on a display (e.g. LCD or LED screen) associated with server 1 and thus be made available to the user. Alternatively or additionally, the information in respect of the configuration of the connections can be automatically recorded once control device 105 is connected to the enclosures by information transferred via the feed-lines connecting the enclosures to the ports. Note that the enclosures are identified in table 1 by an identifier other than the enclosure's SAS address.

As explained above, disk mapping module 117 can be further operable to use the information obtained by ports-data retrieval module 121, and associate each SAS address of each enclosure to its respective port. The last column in Table 2 illustrates the association the SAS address of the enclosure with the corresponding port as performed by disk mapping module 117.

TABLE 2

| | Position of | | Port's | |
|---|---|---|---|---|
| | Enclosure | Port | position in | Enclosure SAS |
| Enclosure | in rack | identifier | vector | address |
| Enclosure 1 | 1 (top) | C2 | 2 | x |
| Enclosure 2 | 2 (middle) | C3 | 3 | y |
| Enclosure 3 | 3 (bottom) | C1 | 1 | z |

The information illustrated in table 2 can be stored in a data-repository, associated with control layer 103. The information which is obtained by disk mapping module 117 and is illustrated in table 2, provides the full physical mapping of the enclosures within the rack. Given a SAS address of an enclosure, management unit 115 is now capable to query the stored information and determine the enclosure's id (in the first column) and its physical location within the rack. In addition to its SAS address, an enclosure can be identified by its SCSI target number, enabling to identify the location of the enclosure in the rack based on the enclosure's SCSI target number.

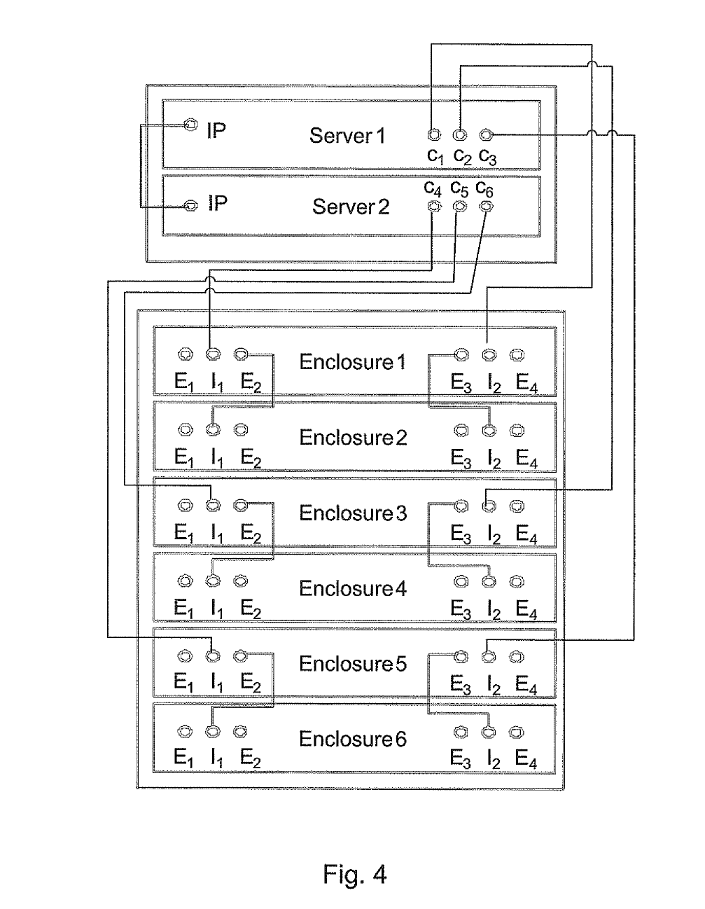

FIG. 4 is a schematic illustration of a second example of architecture of a storage system, in accordance with the presently disclosed subject matter. The system illustrated in FIG. 4 is a more complex system which includes two interconnected servers (server 1, server 2), which are connected to rack 401 the rack comprising 6 disk enclosures (enclosures 1-6). Each server represents a control device 105, both servers being part of control layer 103, as described above with reference to FIG. 1. Each server comprises 3 ports (indicated, by way of example only as C1-C6), wherein each port is connected in parallel to a single enclosure in rack 401.

Note that in the illustrated example, each server is connected to all enclosures, either via a direct connection (e.g. C1 in server 1 is directly connected to disk enclosure 3) or indirectly via a daisy chain (e.g. disk enclosure 3 is connected to disk enclosure 4) such that a port is connected to more than one enclosure only in a serial connection.

As explained above, each port of server 1 and server 2 are associated each with a specific respective position in a vector (provided by ports-data retrieval module 121 e.g. with the help of MPTCTL driver) listing the SAS addresses of the enclosures connected to server 1 and server 2. Thus the position of a port in the vector is indicative of the port which is connected to the enclosure which is listed in that position. As in FIG. 3, the position of the ports in the vector can also correlate with a predefined order of the port and thus the position of a port in the vector can be also indicative of the physical location of that port on control device 105 (e.g. server 1 or 2).

Similar to the previous example, the position of the different ports in the vector can correlate with the physical order of the ports from left to right giving rise to the following order: C1, daisy chain extending from C1, C2, daisy chain extending from C2, C3 and daisy chain extending from C3. It should be noted that although in the current example each port is connected in series to only two enclosures, in other examples more enclosures can be connected in series by additional daisy chains.

According to some implementations, the vector can include the SAS address of enclosures connected to more than one server. In such cases, the order of the ports within the vector can be consecutive e.g. starting in the server 1 and continuing with server 2 (e.g. C1, C2, C3, C4, C5, C6).

As explained above, disk mapping module 117 is operable to utilize ports-data retrieval module 121 to obtain a vector indicating the order of connections of enclosures to server 1. For instance in server 1, the vector representing the order of connections which is obtained is: (Enclosure 3, Enclosure 4, Enclosure 1, Enclosure 2, Enclosure 5, Enclosure 6). The vector representing the order of connection to server 2 which is obtained is: (Enclosure 1, Enclosure 2, Enclosure 5, Enclosure 6, Enclosure 3, Enclosure 4).

As further explained above, each of the enclosures is represented by its SAS address and can be associated with its respective port based on its position within the vector. Management module 109 can be further operable to deduce the physical location of each enclosure within the rack as explained above with reference to FIG. 3.

FIG. 5a is a flowchart illustrating the operations which are performed for determining the location of disks, in accordance with the presently disclosed subject matter. The operations described herein can be performed, for example, by disk mapping module 117 in management unit 115, described above with reference to FIG. 1. A discovery process is run by each HBA (i.e. initiator) which is connected to a control device. During the discovery processes, the SCSI target numbers of the end devices including the disks and enclosures, which are available to each initiator (i.e. within its SAS domain), can be identified (Block 501). Note that in general a discovery process is executed at boot time of the system and in such cases it is not required to execute the process especially for the purpose disclosed herein.

Once the SCSI target numbers of the disks are available, a SCSI command is executed in order to retrieve the SAS addresses of the discovered disks and enclosures (Block 503). At this point, the SCSI target numbers and their corresponding SAS addresses of the disks which are associated with control device 105, are available. The SAS address of each enclosure can be determined based on its SCSI target number in a similar way.

As illustrated in Block 505, the SAS address and serial number of each bay in each enclosure is obtained. To this end SES commands are utilized in order to communicate and obtain information from the enclosures in the rack.

As a bay and its respective disk (i.e. the disk which is attached to the bay) have an identical SAS address, it is possible to associate between the two, based on their SAS address. Accordingly, once the SAS address of the bays is available, each disk is associated with its respective bay by comparing between the SAS addresses of the disks and the bays and determining the respective disk of each bay (Block 507).

After each bay is associated with its respective disk the physical location of the disk is determined, according to the physical location of the bay (Block 509). The physical location of the bay is known from information which maps each bay, identified by its serial number, to its location in its respective enclosure. As the serial number of each bay is known, its location can be deduced from the mapping information.

At this point the available information includes the disks within each enclosure, and their physical location within the enclosure. The disks are identified by their SCSI target number and SAS address.

In case control device 105 is associated with a single enclosure the process can be terminated here. However, in case control device 105 is associated with a plurality of enclosures the location of the enclosures within the rack can be also determined.

FIG. 5b is a flowchart illustrating the operations which are performed for determining the location of enclosures in a rack, in accordance with the presently disclosed subject matter. In order to enable the determination of the location of the enclosures within a rack, data indicative of the SAS addresses of the enclosures which are connected to the same control device, is obtained. As explained above ports data retrieval module 121 enables to obtain data indicative of the SAS addresses of each enclosure connected to control device 105, and the respective port which is connected to an enclosure identified by each SAS address (Block 511). This data can be presented as a vector comprising a list of SAS addresses of the enclosures which are connected to control device 105, where each position within the vector is indicative of a respective port which is connected to the enclosure identified by the SAS address in that position.

Once the vector is obtained, each SAS address can be associated with the respective port, based on the position of the SAS address of the enclosure in the vector (Block 513).

Additional data can be used in order to determine the location of the enclosure in the rack. In one example, this can be performed by locating a respective port of an enclosure on control device 105 and tracking the feed-lines connecting the port to the enclosure. To this end the location of each port on control device 105 is determined. In some cases the location of each SAS address in the vector is indicative of the location of the respective port on control device 105. As explained above, according to one example, the positions in the vector can correlate with the physical order of the ports on server 1, enabling to identify the physical location of a port, based on the location of the corresponding SAS address in the vector. In other cases, each port on control device 105 is labeled with a corresponding identifier and thus, a port which is identified in the vector in the same way can be located on control device 105.

In another example, data explicitly indicating the ports on control device 105 and the location of each enclosure, in the rack, connected to each port, is obtained (Block 515). As demonstrated above with reference to table 1 and table 2, the physical location of an enclosure within the rack can be determined based on the combination of different data originating from different sources. The first data is obtained by ports data retrieval module 121 (block 513 above) and enables to associate between a SAS address and a respective port. The second data is indicative of the location of an enclosure connected to the respective port located on control device 105. It is possible to identify identical ports in the first data and the second data and associate between a SAS address in the first data and location of an enclosure in the second data (Block 517), and determine the location of an enclosure which is identified by its SAS address in the first data.

The full mapping information of disks and enclosures can be stored in a data repository. The full mapping information of disks and enclosures can be displayed on a display associated with control device 105. The display can include for example a list specifying the enclosures in each rack and the disks in each enclosure. The location of the disks and enclosures can be indicated by coordinates. Alternatively or additionally, the map of the enclosures and disks can be displayed graphically, showing for example a graphic model of each rack, indicating the SAS address (and possibly SCSI target number) of the disks and enclosures in the graphical model.

It should be noted that in order to deterministically associate between the SAS address in the vector and its physical location, each port can be connected (in parallel) to a single enclosure. Otherwise, if a port is connected in parallel to more than one enclosure after the respective port is identified, it still remains to determine which of the enclosures connected to that port is the correct enclosure.

FIG. 6a is a flowchart illustrating the operations which are performed for determining the location of disk, in accordance with the presently disclosed subject matter. The operations described above with reference to FIG. 5a are directed for mapping all disks in a rack, enabling to use the obtained information for identifying the location of any given disk within the mapped rack. FIG. 6 proposes a different approach directed for determining the location of a specific disk of interest.

As described in block 601, an identifier of a disk of interest is received. The identifier can be a SCSI target number or SAS address or any other identifier that can be associated with a respective SAS address. In case the identifier is not a SAS address, the identifier is associated with a respective SAS address of the disk of interest and its enclosure (Block 603). For example, in case the identifier is a SCSI target number, the SAS address of the disk of interest is obtained by running an appropriate SCSI command with SCSI target number of the disk of interest. A similar command is used for obtaining the SAS address of the enclosure of interest i.e. the enclosure comprising the disk of interest. In case the identifier is the SAS address of the disk only, the SAS address of the enclosure is retrieved.

With the help of SES commands, the SAS addresses of the bays in the enclosure of interest are obtained (Block 605). Once the SAS addresses of all bays are available, the disk of interest is associated with its respective bay, by searching for a bay with an SAS address which is identical to the SAS address of the disk of interest (Block 607). The physical address of the disk of interest can then be determined, based on the physical address of its respective bay (Block 609). As explained above with reference to FIG. 5a this can be performed based on mapping information providing the physical location of each bay.

As before, if control device 105 is associated with a single enclosure, the process is terminated here. Otherwise, the process continues in order to determine the location of the enclosure containing the disk of interest, within the rack. FIG. 6b is a flowchart illustrating the operations which are performed for determining the location of an enclosure of interest, in a rack, in accordance with the presently disclosed subject matter. In the first stage illustrated in FIG. 6b, data, which is indicative of the SAS addresses which identify each enclosure connected to control device 105, and the respective port which is connected to each of the enclosures, is obtained (Block 611). This data can be obtained with the help of ports data retrieval module 121 and can be provided in the form of a vector, as explained above.

The SAS address of the enclosure of interest is known and can be identified within the obtained data (e.g. the vector) and used to identify the respective port connected to the enclosure of interest (Block 615).

Block 617 discloses a stage of obtaining data indicative of the location of an enclosure connected to the respective port, thereby obtaining a second data. As explained above with reference to FIG. 5b, in one example the order of the SAS address within the vector can be indicative of the location of the respective port on control device 105 and this data can be used to determine the location of an enclosure which is connected to that port. Alternatively, the location of a port on control device 105 can be facilitated with the help of a label indicating the identifier of the ports. Each position in the vector can be associated with an identifier of a port and the corresponding port can be located on the control device 105 based on the labeling of the ports.

As further explained above, in another example, data explicitly indicating the location of an enclosure connected to a port can be obtained and used (see explanation above with reference to table 1 and table 2). The SAS address of the enclosure of interest is associated with its respective port (see Block 615) constituting a first data. The location of the enclosure which is associated with that HBA is also known (see Block 617) constituting a second data. Accordingly, the location of the enclosure of interest can then be determined by associating the first data with the second data (Block 619) as explained above with reference to FIG. 1 and FIG. 5b.

The presently disclosed subject matter further contemplates a GUI (graphic user interface) which is executed by control layer 103 and enables to query the physical location of a disk identified by its SCSI target number or its SAS address. For example, a technician can use the GUI for entering a SCSI target number of a failed disk. The SCSI target can then be processed by management unit 109, which is operable (e.g. by disk mapping module 117) to identify and indicate the physical location of the disk within the rack. Alternatively or additionally, in certain scenarios, control layer 103 can be operable to determine and indicate to the user the location of a disk. For example, together with an error message in respect to failed disk (or enclosure), the location of the failed disk can be determined and displayed to the user (either automatically or upon request from the user).

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

1. For use in a SAS storage system comprising one or more host bus adapters (HBAs), each HBA comprising one or more ports, connecting between said HBA and at least one disk enclosure, each enclosure comprising a plurality of disk drives, each disk drive located in a respective bay, a method of identifying physical location of disk drives in the storage system, the method comprising:
obtaining a SAS address of one or more disk drives among the plurality of disk drives;
obtaining a SAS address of each bay in the respective disk enclosures;
associating, based on the SAS address of the disk drives and bays, between said one or more disk drives among the plurality of disk drives and the respective bays;
obtaining mapping information indicative of the location of said bays in said respective disk enclosure; and
determining, based on the physical location of its respective bay, the physical location, within respective disk enclosures, of said one or more disk drives among said plurality of disk drives.

2. The method of claim 1, wherein said storage system comprises at least one control device comprising a plurality of ports and is connected to a rack comprising a plurality of enclosures, each enclosure operatively connected to a corresponding port, the method further comprising:
obtaining data indicative of, ports connected to each of the enclosures connected to said at least one control device, and of the SAS addresses identifying each of said enclosures, thereby obtaining a first data associating between each port among said plurality of ports and a SAS address of the respective enclosure;
obtaining a second data associating between each port among said plurality of ports and between a location of respective enclosures within the rack; and
associating between the port in said first data and the port in said second data, thereby determining the location of each enclosure identified by a respective SAS address.

3. The method of claim 2 wherein each port is connected in parallel to a single enclosure enabling to deterministically determine the location of each enclosure in said rack.

4. The method of claim 2 wherein said first data is obtained with the help of an MPTCTL driver.

5. The method of claim 2 wherein said first data is in a form of a vector containing the SAS addresses which identify each of the enclosures and wherein position of each SAS address in the vector is indicative of the port connected to the enclosure identified by that SAS address.

6. The method of claim 2 wherein said second data explicitly specifies the location of an enclosure and a respective port connected to each of the enclosures.

7. The method of claim 1 wherein said SAS address of one or more disk drives are obtained with the help of a SCSI command corresponding to a SCSI target numbers of said plurality of drives, said SCSI target numbers being obtained by a discovery process.

8. The method of claim 2 further comprising, receiving an identifier of a disk drive and providing its location in the rack.

9. The method of claim 1 wherein said SAS address of the bays is obtained with the help of SES commands.

10. The method of claim 1 further comprising displaying the location of the disk drives on a display.

11. For use in a SAS storage system comprising one or more host bus adapters (HBAs) each HBA comprising one or more ports, connecting between said HBA and at least one disk enclosure, each enclosure comprising a plurality of disk drives, each disk drive located in a respective bay, a method of identifying the physical location of a disk drive of interest in a storage system, the method comprising:
obtaining a SAS address of the disk drive of interest and a respective enclosure of interest;
obtaining a SAS address of each bay in the respective disk enclosures;
associating between the disk drive of interest and its respective bay, by searching for a bay with a SAS address which is identical to the SAS address of the disk drive of interest; and
obtaining mapping information indicative of the location of said bays in said respective disk enclosure;
identifying in said mapping information data indicative of the locating of said respective bay; and
determining, based on the physical location of said respective bay, the physical location, within respective disk enclosures, of said disk drive of interest.

12. The method of claim 11 wherein the disk drive of interest is identified by its SCSI target number, the method further comprising:
obtaining a SAS address of the disk drive of interest and its enclosure, by running an appropriate SCSI command with the SCSI target number of the disk drive of interest.

13. The method of claim 11, wherein said storage system comprises at least one control device comprising a plurality of ports and is connected to a rack comprising a plurality of enclosures, each enclosure operatively connected to a corresponding port, the method further comprising:
obtaining data indicative of ports connected to each of the enclosures connected to said at least one control device and of the SAS addresses identifying each of said enclosures;
identifying the SAS address of the enclosure of interest within said data and identifying the respective port of the enclosure of interest, thereby obtaining a first data;
obtaining data indicative of the location of an enclosure connected to the respective HBA, thereby obtaining a second data;
associating between the port in said first data and the port in said second data, thereby determining the location of the enclosure of interest in said rack.

14. The method of claim 13 wherein each port is connected in parallel to a single enclosure enabling to deterministically determine the location of said enclosure of interest.

15. The method of claim 13 wherein said first data is obtained with the help of an MPTCTL driver.

16. The method of claim 11 wherein said SAS address of the bays is obtained with the help of SES commands.

17. The method of claim 13 wherein said first data is in a form of a vector containing the SAS addresses which identify each of the enclosures and wherein position of each SAS address in the vector is indicative of a port connected to the enclosure identified by that SAS address.

18. A management unit, operatively connectible to a SAS storage system comprising one or more host bus adapters (HBAs) each HBA comprising one or more ports, connecting between said HBA and at least one disk enclosure, each enclosure comprising a plurality of disk drives, each disk drive located in a respective bay, the management module being operable to receive identifiers of one or more disk drives among the plurality of disk drives;
determine, with the help of a SCSI command corresponding to said identifiers, respective SAS addresses of said one or more disk drives among the plurality of the disk drives and SAS addresses of disk enclosures comprising, respectively, said one or more disk drives among the plurality of the disk drives; obtain SAS address of each bay in the respective disk enclosures; associate, based on the SAS address of the disk drives and bays, between said one or more disk drives among the plurality of disk drives and the respective bays; obtain mapping information indicative of the location of said bays in said respective disk enclosure; and determine, based on the physical address of its respective bay, the physical location, within respective disk enclosures, of said one or more disk drives among said plurality of disk drives.

19. The management unit of claim 18, wherein said SAS storage system comprises at least one control device comprising a plurality of ports and is connected to a rack comprising a plurality of enclosures, each enclosure operatively connected to a corresponding port, wherein the management unit is further operable to receive data indicative of, ports connected to each of the enclosures connected to said at least one control device, and of the SAS addresses identifying each of said enclosures, thereby obtain a first data associating between each port among said plurality of ports and a SAS address of the respective enclosure;
receive a second data associating between each port among said plurality of ports and between a location of respective enclosures within the rack; and associate between the port in said first data and the port in said second data, thereby determining the location of each enclosure identified by a respective SAS address.

20. The management unit of claim 19 wherein each port is connected in parallel to a single enclosure enabling to deterministically determine the location of said enclosure of interest.

21. The management unit of claim 19 being operable to obtain said first data with the help of an MPTCTL driver.

22. The management unit of claim 18 being operable to obtain said SAS addresses of the bays with the help of SES commands.

23. The management unit of claim 19 wherein said first data is in a form of a vector containing the SAS addresses which identify each of the enclosures and wherein position of each SAS address in the vector is indicative of the HBA connected to the enclosure identified by that SAS address.

24. The management unit of claim 18 wherein said identifier is a SCSI target number.

25. A program storage device readable by machine, tangibly embodying a program of instructions executable by the machine to perform method steps of identifying physical location of disk drives in SAS storage system comprising one or more host bus adapters (HBAs), each HBA comprising one or more ports, connecting between said HBA and at least one disk enclosure, each enclosure comprising a plurality of disk drives, each disk drive located in a respective bay, the method comprising:
obtaining SCSI target numbers of one or more disk drives among the plurality of disk drives;
determining, with the help of a SCSI command corresponding to said SCSI target numbers, respective SAS addresses of said one or more disk drives among the plurality of the disk drives and SAS addresses of disk enclosures comprising, respectively, said one or more disk drives among the plurality of the disk drives;
obtaining SAS address of each bay in the respective disk enclosures;
associating, based on the SAS address of the disk drives and bays, between said one or more disk drives among the plurality of disk drives and the respective bays;
obtaining mapping information indicative of the location of said bays in said respective disk enclosure; and
determining, based on the physical address of its respective bay, the physical location, within respective disk enclosures, of said one or more disk drives among said plurality of disk drives.

26. The program storage device of claim 25, wherein the SAS storage system comprises at least one control device comprising a plurality of ports and is connected to a rack comprising a plurality of enclosures, each enclosure operatively connected to a corresponding port, the method further comprising:
obtaining data indicative of, ports connected to each of the enclosures connected to said at least one control device, and of the SAS addresses identifying each of said enclosures, thereby obtaining a first data associating between each port among said plurality of ports and a SAS address of the respective enclosure;
obtaining a second data associating between each port among said plurality of ports and between a location of respective enclosures within the rack; and
associating between the port in said first data and the port in said second data, thereby determining the location of each enclosure identified by a respective SAS address.

27. A program storage device readable by machine, tangibly embodying a program of instructions executable by the machine to perform method stages of claim 11.

28. A program storage device readable by machine, tangibly embodying a program of instructions executable by the machine to perform method stages of claim 13.
